(19) United States
(12) Patent Application Publication
(10) Pub. No.: US 2024/0354554 A1
(43) Pub. Date: Oct. 24, 2024

(54) SYSTEM AND METHOD FOR INCREASING EFFICIENCY IN MODEL CORRECTION IN SUPERVISED SYSTEMS

(71) Applicant: Barracuda Networks, Inc., Campbell, CA (US)

(72) Inventor: Christopher L. Sawtelle, Santa Clara, CA (US)

(21) Appl. No.: 18/425,932

(22) Filed: Jan. 29, 2024

Related U.S. Application Data
(60) Provisional application No. 63/461,205, filed on Apr. 21, 2023.
(60) Provisional application No. 63/546,481, filed on Oct. 30, 2023.

(51) Int. Cl. G06N 3/0455; G06N 3/09

(52) U.S. Cl. CPC G06N 3/0455; G06N 3/09

(57) ABSTRACT

A new approach is proposed to support efficient model and object labeling correction for supervised learning using large language models (LLMs). An LLM engine accepts and collates one or more of a plurality of elements of an incorrect classification/prediction/labeling of an object by a supervised learning system in order to complete preparatory work that a human analyst would perform upon receiving the incorrect classification of the object. Using these elements, the LLM engine analyzes and generates a suggestion/identification on how the plurality of elements are related. In some embodiments, the LLM engine annotates the document with the suggestion/identification and to generate a document in, for a non-limiting example, static HTML format, wherein the document can be inserted into a labeling interface for the human analyst to correct the labeling of the object and/or one more models used by the supervised learning system to classify the object.

### CROSS-REFERENCE TO RELATED APPLICATIONS

This application claims the benefit of U.S. Provisional Patent Application No. 63/546,481, filed Oct. 30, 2023, which is incorporated herein in its entirety by reference.

### BACKGROUND

Supervised machine learning (ML) is a paradigm in machine learning where input objects and one or more desired output values are used to train and produce one or more ML models for classifying the objects or predict outcomes accurately. While the ML models produced through supervised ML systems are becoming increasingly capable, these ML models still require a human expert to design and correct. The supervised ML systems often rely on feedback for corrections and labeling on object classification for increased efficacy. However, the volume of data/objects that are classified by these supervised ML systems is increasing exponentially. As a result, in the supervised ML systems that perform tens of thousands of classifications per day, the volume of incorrect, e.g., false positives and false negatives, classifications of objects become increasingly difficult to manage and be utilized for ML model and object label corrections.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support efficient model and object labeling correction for supervised learning in accordance with some embodiments.

FIG. 2 depicts a flowchart of an example of a process to support efficient model and object labeling correction for supervised learning in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support efficient model and object labeling correction for supervised learning using large language models (LLMs). Under the proposed approach, an LLM engine is configured to accept and collate one or more of a plurality of elements of an incorrect classification/prediction/labeling of an object by a supervised learning system in order to complete preparatory work that a human analyst would perform upon receiving a false positive or false negative classification of the object. Here, the plurality of elements include but are not limited to a target sample/object that has surfaced as being associated with an incorrect classification/prediction/labeling, a specific feedback that is attached to the incorrect classification of the target object, and a document that the human analyst uses as a rubric or taxonomy for labeling of the target object. Using these elements, the LLM engine is configured to analyze and generate a suggestion/identification on how the object, the rubric, and the feedback are related. In some embodiments, the LLM engine is configured to annotate the document with the suggestion/identification and to generate a document in, for a non-limiting example, static HTML format, wherein the document can be inserted into a labeling interface for the human analyst to correct the labeling of the target object and/or one more models used by the supervised learning system to classify the object.

The proposed approach uses an LLM engine, which, when prompted, adjusts and improves decision-making of a supervised learning system based on feedback with speed and accuracy. Since a large portion of the time that human analysts spend is on initial investigation and analysis of a report of incorrect predictions/classifications of objects by the supervised learning system, under the proposed approach, the LLM engine can provide preparatory work of such initial investigation and analysis using the same information as the human analysts while saving them immense amounts of time.

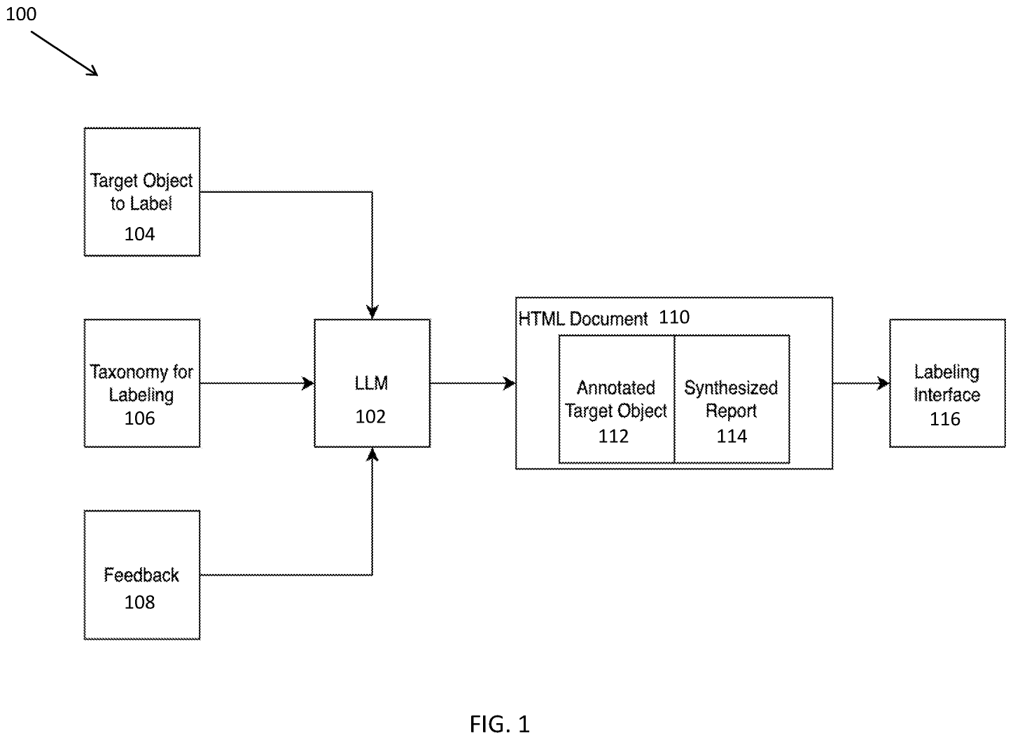

FIG. 1 depicts an example of a system diagram 100 to support efficient model and object labeling correction for supervised learning. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least an LLM engine 102 running one or more LLMs. Each engine in the system 100 runs on one or more computing units/appliances/devices/hosts (not shown) each having one or more processors and software instructions stored in a storage unit, such as a non-volatile memory of the computing unit for practicing one or more processes. When the software instructions are executed, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that, the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google Android device, an iPhone, an iPad, and a voice-controlled speaker or controller. Each engine in the system 100 is associated with one or more communication networks (not shown), which can be but are not limited to, Internet, intranet, wide area network (WAN), local area network (LAN), wireless network, Bluetooth, Wi-Fi, and mobile communication network for communications among the engines. The physical connections of the communication networks and the communication protocols are well known to those skilled in the art.

In the example of FIG. 1, the LLM engine 102 is configured to accept as its input one or more of a plurality of elements associated with an incorrect classification prediction of an object 104 by a supervised learning system. For non-limiting examples, such incorrect prediction can be either a false positive or a false negative classification of the object by the supervised learning system. In some embodiments, the plurality of elements include the object 104 that has been incorrectly classified/misclassified by the supervised learning system. Here, such object 104 can be any data object such as an electronic message (e.g., an email or a short message) or a line in a log file, wherein such object that has been incorrectly classified would normally be a target object to be annotated or labeled by a human analyst. In some embodiments, the plurality of elements further include a feedback 108 specific to/associated with the object, wherein such feedback 108 is used to determine the false positives or false negative classification of the object 104. For non-limiting examples, the feedback 108 can be but is not limited to a customer feedback or an automated action from which the feedback 108 can be derived. In some embodiments, the plurality of elements further include a document or a taxonomy 106, which, for a non-limiting example, can be but is not limited to a set of criteria and/or the definitions of labels such as a training guide that a human analyst would use as a rubric for classifying or labeling the object 104.

Once the plurality of elements associated with the incorrect prediction of the object by a supervised learning system has been accepted, the LLM engine 102 is configured to collate one or more of the plurality of elements using one or more LLMs to complete preparatory analysis on the object 104, similar to what a human analyst would perform upon receiving the incorrect classification, e.g., false positive or false negative classification, of the object 104. Here, each of the one or more LLMs can be a type of artificial intelligence (AI) algorithm that uses deep learning techniques (e.g., deep neural network models) and large datasets to perform natural language processing (NLP) tasks by recognizing natural language content of the one or more of the plurality of elements. In some embodiments, the LLM engine 102 is further configured to utilize one or more multimodal models to collate the one or more of the plurality of elements. Here, each of the one or more multimodal models is an ML model that typically includes one or more neural networks each specialized in analyzing a particular modality. Each of the one or more multimodal models can process information from one of multiple sources, such as text, images, audio, and video, etc., to build a more complete understanding of content of the one or more of the plurality of elements and unlock new insights into the misclassification of the object. For example, the LLM engine 102 is configured to combine the misclassified target object 104 with the predefined taxonomy/document 106 and/or feedback 108 associated with the target object 104 for preparatory analysis of the misclassification of the target object 104 based on the one or more LLMs and/or multimodal models.

In some embodiments, the LLM engine 102 is configured to generate a document 110 about the misclassified target object 104 in accordance with the preparatory analysis of the one or more of the plurality of elements, e.g., the taxonomy 106 for labeling and feedback 108. In some embodiments, the document 110 is a HTML document code-generated by the one or more LLMs and/or multimodal models. In some embodiments, the document 110 includes the target object 104 with annotations explaining why the target object 104 is misclassified and/or suggestion/identification on how to correct the classification. In some embodiments, the document 110 includes a synthesized report 114 covering the combination of the one or more of the plurality of elements using the one or more LLMs and/or multimodal models.

Once the document 110 has been generated, the LLM engine 102 is configured to present the document 110 to a human analyst by inserting the document 110 into a labeling interface 116 to correct labeling and/or one or more models used to classify the object by the supervised learning system. In some embodiments, the labeling interface 116 can be an Application Programming Interface (API) provided by the LLM engine 102 for labeling of the target object 104. In some embodiments, the labeling interface 116 enables the human analyst to access the document 110 regarding the misclassification of the target object 104, make corrections to one or more ML models used by the supervised learning system, and apply the correct label to the target object 104.

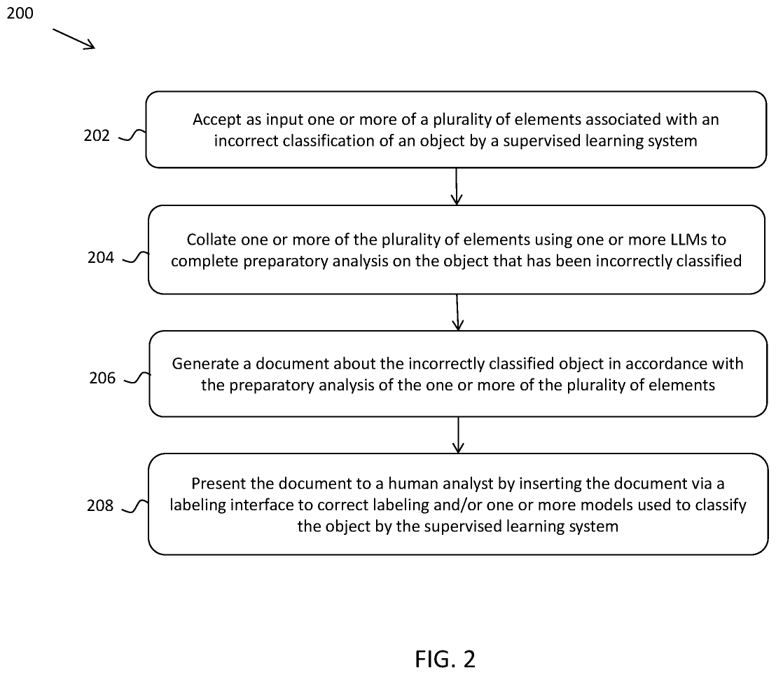

FIG. 2 depicts a flowchart 200 of an example of a process to support efficient model and object labeling correction for supervised learning. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202, where one or more of a plurality of elements associated with an incorrect classification of an object by a supervised learning system are accepted as input. The flowchart 200 continues to block 204, where one or more of the plurality of elements are collated using one or more LLMs to complete preparatory analysis on the object that has been incorrectly classified. The flowchart 200 continues to block 206, where a document about the incorrectly classified object is generated in accordance with the preparatory analysis of the one or more of the plurality of elements. The flowchart 200 ends at block 208, where the document is presented to a human analyst by inserting the document via a labeling interface to correct labeling and/or one or more models used to classify the object by the supervised learning system.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine-readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system, comprising:
a large language model (LLM) engine configured to
accept as input one or more of a plurality of elements associated with an incorrect classification of an object by a supervised learning system;
collate one or more of the plurality of elements using one or more LLMs to complete preparatory analysis on the object that has been incorrectly classified;
generate a document about the incorrectly classified object in accordance with the preparatory analysis of the one or more of the plurality of elements;
present the document to a human analyst by inserting the document via a labeling interface to correct labeling and/or one or more models used to classify the object by the supervised learning system.

2. The system of claim 1, wherein:
the object is a an electronic message or a line in a log file.

3. The system of claim 1, wherein:
the incorrect classification is a either a false positive or a false negative classification of the object by the supervised learning system.

4. The system of claim 1, wherein:
the plurality of elements include the object that has been incorrect classified by the supervised learning system.

5. The system of claim 4, wherein:
the plurality of elements further include a specific feedback associated with the object, wherein such feedback is used to determine the classification of the object.

6. The system of claim 5, wherein:
the plurality of elements further include a taxonomy of a set of criteria and/or the definitions of labels used for classifying the object.

7. The system of claim 6, wherein:
the LLM engine is configured to combine the incorrectly classified object with the taxonomy and/or the feedback associated with the object for preparatory analysis of misclassification of the object based on the one or more LLMs.

8. The system of claim 1, wherein:
each of the one or more LLMs is a type of artificial intelligence (AI) algorithm that uses deep learning techniques and large datasets to perform natural language processing (NLP) tasks by recognizing natural language content of the one or more of the plurality of elements.

9. The system of claim 1, wherein:
the LLM engine is configured to utilize one or more multimodal models to collate the one or more of the plurality of elements.

10. The system of claim 9, wherein:
each of the one or more multimodal models is an ML model that includes one or more neural networks each specialized in analyzing a particular modality.

11. The system of claim 9, wherein:
each of the one or more multimodal models processes information from one of a plurality of sources to understand content of the one or more of the plurality of elements and unlock insights into the incorrect classification of the object.

12. The system of claim 1, wherein:
the document is a HTML document code-generated by the one or more LLMs.

13. The system of claim 1, wherein:
the document includes the object with annotations explaining why the object is incorrectly classified and/or a suggestion on how to correct the classification.

14. The system of claim 1, wherein:
the document includes a synthesized report covering combination of the one or more of the plurality of elements using the one or more LLMs.

15. A computer-implemented method, comprising:
accepting as input one or more of a plurality of elements associated with an incorrect classification of an object by a supervised learning system;
collating one or more of the plurality of elements using one or more LLMs to complete preparatory analysis on the object that has been incorrectly classified;
generating a document about the incorrectly classified object in accordance with the preparatory analysis of the one or more of the plurality of elements;
presenting the document to a human analyst by inserting the document via a labeling interface to correct labeling and/or one or more models used to classify the object by the supervised learning system.

16. The method of claim 15, wherein:
the incorrect classification is a either a false positive or a false negative classification of the object by the supervised learning system.

17. The method of claim 15, wherein:
the plurality of elements include one or more of:
the object that has been incorrect classified by the supervised learning system;
a specific feedback associated with the object, wherein such feedback is used to determine the classification of the object;
a taxonomy of a set of criteria and/or the definitions of labels used for classifying the object.

18. The method of claim 17, further comprising:
combining the incorrectly classified object with the taxonomy and/or the feedback associated with the object for preparatory analysis of misclassification of the object based on the one or more LLMs.

19. The method of claim 15, further comprising:
utilizing one or more multimodal models to collate the one or more of the plurality of elements, wherein each of the one or more multimodal models is an ML model that includes one or more neural networks each specialized in analyzing a particular modality.

20. The method of claim 19, further comprising:
processing information from one of a plurality of sources via each of the one or more multimodal models to understand content of the one or more of the plurality of elements and unlock insights into the incorrect classification of the object.

21. The method of claim 15, wherein:
the document is a HTML document code-generated by the one or more LLMs.

22. The method of claim 21, wherein:
the document includes one or more of:
the object with annotations explaining why the object is incorrectly classified and suggestion on how to correct the classification;
a synthesized report covering combination of the one or more of the plurality of elements using the one or more LLMs.

23. A non-transitory storage medium having software instructions stored thereon that when executed cause a system to:
accept as input one or more of a plurality of elements associated with an incorrect classification of an object by a supervised learning system;
collate one or more of the plurality of elements using one or more LLMs to complete preparatory analysis on the object that has been incorrectly classified;
generate a document about the incorrectly classified object in accordance with the preparatory analysis of the one or more of the plurality of elements;
present the document to a human analyst by inserting the document via a labeling interface to correct labeling and/or one or more models used to classify the object by the supervised learning system.
